(19) United States
(12) Patent Application Publication
(10) Pub. No.: US 2020/0024151 A1
(43) Pub. Date: Jan. 23, 2020

(54) METHOD OF EXTRACTING AND SEPARATING ZIRCONIUM AND HAFNIUM FROM HYDROCHLORIC ACID MEDIUM

(71) Applicant: SOUTH-CENTRAL UNIVERSITY FOR NATIONALITIES, Wuhan (Hubei) (CN)

(72) Inventors: Zhigao XU, Wuhan (Hubei) (CN); Hongyang HE, Wuhan (Hubei) (CN); Fei XU, Wuhan (Hubei) (CN); Ming WU, Wuhan (Hubei) (CN); Wenjie ZHANG, Wuhan (Hubei) (CN); Zhengyan HE, Wuhan (Hubei) (CN); Rong ZHANG, Wuhan (Hubei) (CN)

(21) Appl. No.: 16/203,984

(22) Filed: Nov. 29, 2018

Related U.S. Application Data
(63) Continuation-in-part of application No. PCT/CN2018/072336, filed on Jan. 12, 2018.

(30) Foreign Application Priority Data
Jan. 3, 2018 (CN) 201810005419.4

(51) Int. Cl. C01G 27/00; C01G 25/00

(52) U.S. Cl. CPC C01G 27/003; C01G 25/003

(57) ABSTRACT

Provided is a method of extracting and separating zirconium and hafnium from hydrochloric acid medium, which relates to the technical field of fine separation of substance. Primarily, extraction is performed to acidic raw liquid containing zirconium compounds by a synergistic extraction system consisting of DIBK and phosphonic acids extraction agent, so that the zirconium goes to the aqueous phase and the hafnium goes to the organic phase, thus the separation is achieved. No toxic substance is involved throughout the process, so clean production is achieved.

### CROSS REFERENCE TO RELATED APPLICATIONS

The present disclosure is a continuation-in-part application based on international patent application No. PCT/CN2018/072336, filed on Jan. 12, 2018 and entitled “Method of Extracting and Separating Zirconium and Hafnium from Hydrochloric Acid Medium” and the international patent application claims the priority of the Chinese Patent Application with the filling No. 2018100054194, entitled “Method of Extracting and Separating Zirconium and Hafnium from Hydrochloric Acid Medium”, which are incorporated herein by reference in their entirety.

### TECHNICAL FIELD

The present disclosure relates to the technical field of purification, and specifically to a method of extracting and separating zirconium and hafnium from hydrochloric acid medium.

### BACKGROUND ART

Zirconium and hafnium are symbiotic in the nature. Commercially available zirconium-containing chemicals normally contain a relatively low content of hafnium (m_{Hf}/m_{(Zr+Hf)}) (generally at 1˜3%). It would be advantageous to use an extraction agent which selectively extracts hafnium in the separation. Due to lanthanide contraction, zirconium and hafnium have substantially identical atomic radius and ionic radius, and exactly similar physical and chemical properties, so it is very hard to separate them. They are seen as two of the elements that are most difficult to separate in the periodic table of elements. However, zirconium and hafnium have different nuclear performances. With a small thermal neutron absorption cross-section, zirconium is widely used as the material for making nuclear reactor cladding and structure. It is required that nuclear grade zirconium should contain a hafnium content lower than 0.01%. In contrast, hafnium has a large thermal neutron absorption cross-section and is mainly used in the neutron control rod in nuclear reaction. It is required that nuclear grade hafnium should contain a zirconium content lower than 2%. Therefore, separating zirconium and hafnium is the technical key to obtain nuclear grade zirconium and hafnium materials.

Nuclear power is an economic and efficient clean energy which does not emit sulfur dioxide, smoke, nitrogen oxides and carbon dioxide. Replacing partial thermal power with nuclear power not only reduces coal exploitation, transportation and total combustion capacity, but also is an effective path to reduce emission of pollutants in electric power industry. Moreover, it is an important measure to slow down global greenhouse effect. Countries have been making a great effort to develop nuclear power in recent years. This facilitates the development of and concern to zirconium and hafnium separation technologies. Many zirconium and hafnium separation methods have been developed, e.g. molten salt rectification method, ion exchange method and solvent extraction method. Solvent extraction method becomes the main method of separating zirconium and hafnium due to a series of outstanding advantages, e.g. quick equilibrium, good separation result, large handling capacity, continuous operation if desired and low cost. By extraction system, there are neutral extraction system, acidic extraction system, basic extraction system, chelate extraction system and synergistic extraction system. Currently, among those reported extraction agents and systems, only MIBK, Cyanex 301, Cyanex 302 and D2EHPA and so on selectively extract hafnium present in zirconium-containing chemicals at a relatively low content. All of them, except MIBK, extract from dilute solution (containing <10 g/L zirconium). This is not desired for industrial application.

MIBK method was developed in 1970s in USA and meant for industrial production. Nearly ⅔ of nuclear grade zirconium and hafnium in the world are applied such method to separated zirconium and hafnium. MIBK method selectively extracts hafnium present at a relatively low content between zirconium and hafnium from hydrochloric acid medium in the presence of SCN⁻, and zirconium with a relatively high content is left in the aqueous phase. In this way, zirconium and hafnium are separated (with a separation coefficient up to about 9 for zirconium and hafnium). The extraction agent has a large capacity and a high efficiency. However, MIBK method has some defects: (1) MIBK has a solubility up to 1.7 wt % in water (one of the extraction agents with highest solubility in water), which means a high solvent loss; (2) it involves unstable thiocyanic acid (and thiocyanate) which is likely to decompose and produce toxic decomposition products e.g. hydrogen sulfide, methyl mercaptan and CN⁻ under acidic condition, which contaminate the environment; (3) MIBK has a certain smell which degrades the environment in the workshop; (4) MIBK has a low flash point and thus is likely to start a fire. The drawbacks presented in MIBK process indicates the necessity of improvement or replacement.

Diisobutyl ketone (DIBK) is a neutral oxygen-containing extraction agent which has a similar structure to MIBK. Both of them have similar extraction performances and similar extraction mechanisms. The difference in structure leads to difference in properties as extraction agents. For example, DIBK has a flash point of 47° C., whereas MIBK has a flash point of only 22.78° C.; the water solubility of DIBK is 0.043 wt %, whereas that of MIBK is up to 1.7 wt %. Exactly due to these defects, MIBK method is restrained from industrial application.

Currently, thiocyanic acid or salts thereof are involved if diisobutyl ketone (DIBK) is used as an extraction agent to separate zirconium and hafnium. For their relatively high toxicity, thiocyanic acid or salts thereof are not environmentally friendly during separation.

### SUMMARY

A purpose of the present disclosure is to provide a method of extracting and separating zirconium and hafnium from hydrochloric acid medium. It involves no toxic substances during separation process and thus enables clean the zirconium and hafnium separation process.

Another purpose of the present disclosure is to provide a method of extracting and separating zirconium and hafnium from hydrochloric acid medium, which may be applied to hafnium-containing zirconium compounds for separation of zirconium and hafnium.

The embodiments of the present disclosure are implemented in the following way.

The first aspect of the present disclosure is to mix an extraction agent with acidic raw liquid formed by mixing a zirconium-containing chemical and hydrochloric acid for extraction, mix the resultant raffinate from phase separation of the extraction with a base solution to give zirconium hydroxide precipitate, strip the hafnium-containing loaded organic phase with carbonate solution, mix the stripping liquid with a base solution to give hafnium hydroxide precipitate, roast the zirconium hydroxide precipitate and the hafnium hydroxide precipitate. The extraction agent includes the mixture of diisobutyl ketone (DIBK) and phosphonic acids extraction agent (containing C—P bond).

Preferably, the phosphonic acids extraction agent (containing C—P bond) is at least one selected from the group consisting of Cyanex 921, Cyanex 923, Cyanex 925 and Cyanex 572.

Preferably, the hydrochloric acid is pre-extracted with the extraction agent before extraction.

Preferably, the hydrochloric acid has a concentration of 1.0-4.0 mol/L in pre-extraction, and/or the extraction agent is isometric with the hydrochloric acid in pre-extraction.

Preferably, the acidic raw liquid further includes an inorganic salt.

The second aspect of the present disclosure is to mix a zirconium-containing chemical and hydrochloric acid to make acidic raw liquid, perform extraction to the acidic raw liquid with an extraction agent, extract resultant raffinate and hafnium-containing loaded organic phase after phase separation, mix the raffinate with a base solution to give zirconium hydroxide precipitate, strip the hafnium-containing loaded organic phase with a carbonate solution, mix the stripping liquid with a base solution to give hafnium hydroxide precipitate, roast the zirconium hydroxide precipitate and the hafnium hydroxide precipitate. The extraction agent includes the mixture of DIBK and phosphonic acids extraction agent (containing C—P bond).

The embodiments of the present disclosure provide the following beneficial effects. A synergistic extraction system consisting of DIBK and Cyanex 923 or a synergistic extraction system consisting of DIBK and phosphonic acids extraction agent (containing C—P bond) has less mass transfer and large extraction capacity as they selectively extract hafnium presented at a relatively low content in mixed solution of zirconium and hafnium. The process is simple in procedures and easy to operate. The extraction is highly efficient. Further, no highly toxic substances, e.g. thiocyanic acid or salts thereof are involved in such separation process. Therefore, the entire separation process is clean.

### DETAILED DESCRIPTION OF EMBODIMENTS

To make the purposes, technical solutions and advantages of the embodiments of the present disclosure much clearer, the technical solutions in the embodiments of the present disclosure will be clearly and completely described below. Examples for which no specific condition is indicated should be performed under conventional conditions or as recommended by the manufacturer. All those agents or instruments for which no manufacturer is indicated are all conventional products which are commercially available.

Now the method of separating zirconium and hafnium provided in the present disclosure will be described as below in details.

Zirconium and hafnium are symbiotic in the nature. Commercially available zirconium-containing chemicals normally contain a relatively low hafnium content (m_{Hf}/m_{(Zr+Hf)}) (generally at 1˜3%). It would be advantageous to use an extraction agent which selectively extracts hafnium in the separation. Due to “lanthanide contraction”, zirconium and hafnium have substantially identical atomic radius and ionic radius, and exactly similar physical and chemical properties, so it is very hard to separate them. They are seen as two of the elements that are most difficult to separate in the periodic table of elements. However, zirconium and hafnium have different nuclear performances. With a small thermal neutron absorption cross-section, zirconium is widely used as the material for making nuclear reactor cladding and structure. It is required that nuclear grade zirconium should contain a hafnium content lower than 0.01%. In contrast, hafnium has a large thermal neutron absorption cross-section and is mainly used in the neutron control rod in the nuclear reaction. It is required that nuclear grade hafnium should contain a zirconium content lower than 2%. Therefore, separating zirconium and hafnium is the key to obtain nuclear grade zirconium and hafnium materials.

As an aspect of the present disclosure, the present disclosure provides a method of extracting and separating zirconium and hafnium from hydrochloric acid medium, which is mainly used to efficiently separate zirconium and hafnium and includes the following steps.

There are many factors which may affect separation of zirconium and hafnium in the system where solvent extraction method is used to separate zirconium and hafnium in the present disclosure, including volume percentage of the extraction agent, concentrations of zirconium and hafnium in the raw liquid, concentration of sulfate, concentration of chloride ions, total acidity of free acids and molar concentration of carbonate solution in stripping. To improve the separation result, the concentration of each component in the prepared acidic raw liquid is controlled in some embodiments of the present disclosure, as follows.

If the zirconium ions and hafnium ions are present in the raw liquid at a total concentration lower than 0.05 mol/L, which may facilitate separation of zirconium and hafnium, but the raw liquid handling capacity would be relatively large and so is the total acid consumption. If the zirconium ions and hafnium ions are present in the raw liquid at a total concentration higher than 2.0 mol/L, where the total acidity of free acids is less than 0.05 mol/L, the zirconium and hafnium are likely to hydrolyze, hence, the separation is not efficient; where the total acidity of free acids is more than 4.0 mol/L, the zirconium and hafnium separation coefficient decreases. To ensure a relatively high separation efficiency of zirconium and hafnium, it is optimum that the zirconium ions and hafnium ions are present in the raw liquid at a total concentration of 0.05˜2.0 mol/L, preferably 0.5˜1.5 mol/L, more preferably 1.0˜1.5 mol/L.

The total acidity of free acids in the raw liquid is 0.5˜4.0 mol/L, preferably 1.0˜2.5 mol/L.

In addition, preferably, the concentration of chloride ions in the acidic raw liquid is preferably controlled within 0.5-5.0 mol/L. Optionally, inorganic salt may be introduced into the acidic raw liquid. Where sulfate is added to the acidic raw liquid as inorganic salt, sulfate ions may also be introduced. Preferably, the concentration of sulfate ions is controlled within 0˜1.25 mol/L, e.g. the concentration of sulfate ions of 0.2 mol/L, 0.4 mol/L, 0.5 mol/L, 0.6 mol/L, 0.8 mol/L, 1.0 mol/L and 1.25 mol/L.

Optionally, ammonium hydroxide or the like may also be added to the acidic raw liquid to adjust the pH value of the acidic raw liquid.

Extraction is performed to the prepared acidic raw liquid with an extraction agent. In the above, the extraction agent includes DIBK and a synergistic extraction system consisting of DIBK and phosphonic acids extraction agent (containing C—P bond). The phosphonic acids extraction agent is at least one selected from the group consisting of Cyanex 921, Cyanex 923, Cyanex 925 and Cyanex 572. That is to say, the synergistic extraction system formed with DIBK and Cyanex 921 may be used, the synergistic extraction system formed with DIBK and Cyanex 923 may also be used, the synergistic extraction system formed with DIBK and Cyanex 925 may also be used, and the synergistic extraction system formed with DIBK and Cyanex 572 may also be used. In some embodiments of the present disclosure, the synergistic extraction system formed with DIBK, Cyanex 921, Cyanex 923, Cyanex 925 and Cyanex 572 may also be used. Compared with liquid-liquid extraction using a single extraction agent, synergistic extraction is more efficient.

In the above, diisobutyl ketone (DIBK) is a neutral oxygen-containing extraction agent. DIBK has a flash point of 47° C. and a water solubility of 0.043 wt %, and thus it is hardly soluble in water.

In some embodiments of the present disclosure, in terms of extraction agent, where a synergistic extraction system formed with DIBK and phosphonic acids extraction agent (containing C—P bond) is used, the phosphonic acids extraction agent (containing C—P bond) is present at a volume percentage preferably of 2˜40%, more preferably 2˜20%. It is also to be noted that in the synergistic extraction system, extraction agents with similar properties to Cyanex 921 or Cyanex 923 or Cyanex 925 or Cyanex 572 may be used to replace Cyanex 921 or Cyanex 923 or Cyanex 925 or Cyanex 572, or other extraction agents with similar properties to them may further be added.

Phosphonic acids extraction agent (containing C—P bond) is an organic phosphine oxide-based extraction agent. When other factors are constant, as the volume percentage of phosphonic acids extraction agent (containing C—P bond) increases, the value of its zirconium-hafnium separation coefficient increases first and then decreases. When the volume percentage concentration of the phosphonic acids extraction agent (containing C—P bond) is bigger than 40% (v/v), the extraction amount of zirconium would be too large, which is bad for separation of zirconium and hafnium. Therefore, it is optimum that it is present at a content within 2˜20% (v/v).

The extraction may be done in a single-stage or multi-stage (e.g. 4˜20 stages) co-current flow and/or counterflow manner. The two phases are mixed for 2˜30 min, preferably 5˜15 min. The intra-tank temperature within the extraction tank is preferably kept within 0˜40° C., e.g. at 5° C., 10° C., 15° C., 20° C., 25° C., 30° C. and 35° C.

The studies on the extraction mechanisms by which the reported MIBK system, DIBK-TBP system, DIBK-P204 system, DIBK-P350 system and DIBK-TOPO system work on zirconium and hafnium suggest that where SCN⁻ is present, SCN⁻ is directly involved in the composition of the extracted complexes. By Lewis's soft-hard-acid-base theory, both Hf⁴⁺ and Zr⁴⁺ are hard acids, but Hf⁴⁺ has a stronger acidity than Zr⁴⁺ and is more likely to form relatively stable complexes with hard basic extraction agents. Phosphonic acids extraction agents (containing C—P bond) have a stronger Lewis basicity than phosphoric acids extraction agents (containing C—O—P bond), and are more likely to form relatively stable extracted complexes with Hf⁴⁺ which has a small ionic radius, meaning, it is easy to be extracted. A synergistic extraction system consisting of DIBK, which has a big steric hindrance and a strong selectivity, and phosphonic acids extraction agent (containing C—P bond) selectively extracts hafnium, which significantly improves the extraction rate of hafnium and separation efficiency of zirconium and hafnium.

In some embodiments of the present disclosure, the extraction agent may be diluted by mixing with a diluent in advance which may be selected from sulfonated kerosene, hexane, isooctane and 200# solvent oil, etc. It should be understood that the diluent may consist of one or at least two of the above substances.

The extraction agent is mixed with hydrochloric acid for pre-extraction. In the above, the hydrochloric acid is preferably at a concentration of 1.0˜4.0 mol/L, e.g. at 1.0 mol/L, 1.5 mol/L, 2.0 mol/L, 2.5 mol/L, 3.0 mol/L, 3.5 mol/L and 4.0 mol/L. The pre-extraction is done for the extraction agent to reach pre-saturation. During pre-extraction, the extraction agent is preferably isometric with the hydrochloric acid.

After pre-extraction, the extraction agent is the organic phase, and the acidic raw liquid is the aqueous phase. The two of them are mixed for extraction. After phase separation of extraction, zirconium is left in the raffinate phase and zirconium solution containing no or little hafnium is obtained. The hafnium in the aqueous phase goes to the organic phase and hafnium-containing loaded organic phase is obtained.

Zirconium in the hafnium-free zirconium solution as obtained is precipitated with a base solution (e.g. ammonium hydroxide and caustic soda) to give zirconium hydroxide precipitate.

The hafnium-containing loaded organic phase is stripped with a carbonate solution. Optionally, the carbonate may be sodium carbonate, sodium bicarbonate, potassium carbonate, potassium bicarbonate, ammonium carbonate, magnesium carbonate and aluminum carbonate, etc. In stripping, the carbonate may be one or the mixture of at least two of the above substances. After the stripping, hafnium goes to the aqueous phase. The resulted stripping liquid is hafnium-rich solution. Weight ratio (m_{Hf}/m_{(Hf+Zn)}) is 10˜40% in the resulted hafnium-rich solution. In the above, the concentration of the carbonate used in stripping may be e.g. 0.05˜5.0 mol/L.

Then hafnium in the hafnium-rich solution is precipitated with a base solution (e.g. ammonium hydroxide and caustic soda) to give hafnium hydroxide precipitate.

The zirconium hydroxide precipitate and the hafnium hydroxide precipitate as obtained are washed with deionized water. The washed zirconium hydroxide precipitate and hafnium hydroxide precipitate are roasted. Preferably, the roasting is done at a temperature of 600˜2300° C., e.g. at 800° C., 1000° C., 1200° C., 1400° C., 1600° C. and 1800° C. The roasting may also be done under rising temperature at a gradient.

The zirconium oxide obtained from roasting is at the nuclear grade. The zirconium-containing hafnium oxide may also reach the nuclear grade after further separation.

As another aspect of the present disclosure, the present disclosure provides a method of extracting and separating zirconium and hafnium from hydrochloric acid medium, which is mainly applied to efficient separation of zirconium and hafnium. This method is substantially same with the above separation method. The only difference lies in that the acidic raw liquid is prepared before extraction.

First, the raw liquid containing zirconium and hafnium to be separated is made into acidic raw liquid, which is to mix the zirconium-containing chemical with hydrochloric acid in order to prepare acidic raw liquid. Preferably, inorganic salt may be added to the acidic raw liquid. The inorganic salt may be at least one selected from the group consisting of ammonium chloride, sodium chloride, magnesium chloride, ammonium sulfate, sodium sulfate and magnesium sulfate.

In some embodiments of the present disclosure, a certain amount of ammonium hydroxide may also be added to the acidic raw liquid to adjust the pH value of the acidic raw liquid.

The acidic raw liquid may be prepared, for example, by the following methods.

I. Subject zirconite to carbonize and chlorinate, or directly to boiling chlorination to prepare zirconium tetrachloride; dissolve the zirconium tetrachloride in water, to which ammonium hydroxide and inorganic salt are added to make acidic raw liquid; wherein the ammonium hydroxide and inorganic salt may be added quantitatively.
II. Subject zirconite to alkali fusion, wash and dip the same in diluted hydrochloric acid to give solution, to which quantified hydrochloric acid and inorganic salt are added to make acidic raw liquid.
II. Directly dissolve zirconium oxychloride in water and add quantified hydrochloric acid and inorganic salt to make acidic raw liquid.
IV. Prepare raw liquid by the method I or method II with zirconium oxide, zirconium metal, hafnium oxide, hafnium metal, or zirconium waste or hafnium waste containing other impurities, to which quantified hydrochloric acid and inorganic salt are added to make acidic raw liquid.

In the acidic raw liquid prepared by the above methods, the compositions of the raw liquid are basically as shown in Table 1.

TABLE 1
Compositions of acidic raw liquid

| | Total concentration of | | Total acidity | | |
|---|---|---|---|---|---|
| | zirconium and hafnium | Hafnium content | of free acids | Chloride ions | Sulfate ions |
| Component | (mol/L) | (m_{Hf}/m_{(Hf+Zr)} %) | (mol/L) | (mol/L) | (mol/L) |
| Concentration | 0.05~2.0 | 0.5~97.0 | 0.5~4.0 | 0.5~5.0 | 0~1.25 |

Now the characteristics and performances of the present disclosure will be further described in detail, in combination with the following examples.

### Example 1

A method of separating zirconium and hafnium, including the specific following steps:

(1) Preparing acidic raw liquid: the aqueous phase consists of zirconium and hafnium ions at an initial total concentration of 1.5 mol/L; wherein the hafnium ions are present at a concentration of about 0.018 mol/L; the aqueous phase has an acidity of 1.7 mol/L; (NH₄)₂SO₄ is present at a concentration of 0.8 mol/L.
(2) The mixed organic phase consisting of DIBK by 90% (v/v) and Cyanex 923 by 10% (v/v) is used as the extraction agent. Firstly, pre-extraction is performed to 3.5 mol/L isometric hydrochloric acid with the extraction agent. Then the extraction agent after pre-extraction is used as the organic phase, and the acidic raw liquid is used as the aqueous phase. The phase ratio (organic phase:aqueous phase) is controlled at 2:1. Single-stage extraction is performed to the raw liquid at room temperature. The two phases are mixed for 10 min. After phase separation, zirconium is left in the raffinate, and zirconium solution containing little hafnium is obtained. Then zirconium in the zirconium solution is precipitated with ammonium hydroxide to give zirconium hydroxide precipitate, and all hafnium in the raw liquid is extracted to the organic phase to give hafnium-containing loaded organic phase.
(3) The loaded organic phase is stripped with 1.0 mol/L potassium carbonate solution. The phase ratio (organic phase:aqueous phase) in stripping is kept at 1:2. The two phases are mixed for 10 min. Hafnium-rich solution containing zirconium is obtained. Then hafnium in this solution is precipitated with ammonium hydroxide to give hafnium hydroxide precipitate.
(4) The zirconium hydroxide precipitate and the hafnium hydroxide precipitate are washed with deionized water, respectively. The washed zirconium hydroxide precipitate and hafnium hydroxide precipitate are roasted at 1200° C., respectively, to give zirconium oxide product containing little hafnium and hafnium oxide product containing little zirconium.

The total concentrations of zirconium and hafnium metal ions in the aqueous phase before and after extraction are measured by titrimetry with standard EDTA solution. The acidity is measured by titrimetry with standard sodium hydroxide solution. The hafnium concentration is measured by inductively coupled plasma mass spectrometry (ICP-MS). The total concentration of zirconium and hafnium metal ions and the concentration of hafnium ions in the organic phase are calculated by minusing, respectively. The distribution ratio, separation coefficient and extraction rate are calculated in sequence.

The concentration of metal ions in the organic phase, the distribution ratio between zirconium and hafnium, the separation coefficient and the extraction rate are calculated by the following formulas, respectively.

$$\begin{matrix}{[ Zr ]}_{o} = \frac{( {C}_{Zr}^{0} - {[ Zr ]}_{a} ) \times {V}_{a}}{{V}_{o}} & ( 1 ) \\ {[ Hf ]}_{o} = \frac{( {C}_{Hf}^{0} - {[ Hf ]}_{a} ) \times {V}_{a}}{{V}_{o}} & ( 2 ) \\ {D}_{r ( Zr )} = \frac{{[ Zr ]}_{eo}}{{[ Zr ]}_{ea}} = \frac{{C}_{Zr}^{0} - {[ Zr ]}_{ea}}{{[ Zr ]}_{ea}} & ( 3 ) \\ {D}_{r ( Hf )} = \frac{{[ Hf ]}_{eo}}{{[ Hf ]}_{ea}} = \frac{{C}_{Hf}^{0} - {[ Hf ]}_{ea}}{{[ Hf ]}_{ea}} & ( 4 ) \\ β = \frac{{D}_{r ( Hf )}}{{D}_{r ( Zr )}} & ( 5 ) \\ {E}_{Zr} = \frac{{C}_{Zr}^{0} - {[ Zr ]}_{ea}}{{C}_{Zr}^{0}} \times 100 \% & ( 6 ) \\ {E}_{Hf} = \frac{{C}_{Hf}^{0} - {[ Hf ]}_{ea}}{{C}_{Hf}^{0}} \times 100 \% & ( 7 )\end{matrix}$$

Where: [Zr]ₒ, [Hf]ₒ represent the concentrations of zirconium and hafnium in the organic phase, respectively, in g/L;
[Zr]ₐ, [Hf]ₐ represent concentrations of zirconium and hafnium in the aqueous phase, respectively, in g/L;
C_{Zr}⁰, C_{Hf}⁰ represent initial concentrations of zirconium and hafnium ions in the aqueous phase, respectively, in g/L;
Vₐ, Vₒ represent volumes of the aqueous phase and the organic phase, respectively, in mL;
D_{r(Zr)}, D_{r(Hf)} represent the distribution ratios of zirconium and hafnium, respectively;
[Zr]ₑₐ, [Hf]ₑₐ represent concentrations of zirconium and hafnium ions in the aqueous phase at the time of equilibrium, respectively, in g/L;
[Zr]ₑₒ, [Hf]ₑₒ represent concentrations of zirconium and hafnium ions in the organic phase at the time of equilibrium, respectively, in g/L;
β represents the separation coefficient of zirconium and hafnium;
E_{Zr}, E_{Hf} represent the extraction rates of the organic phase for zirconium and hafnium, respectively.

By calculation, the system has an extraction rate of 82.50% for hafnium, and an extraction rate of 14.50% for zirconium. The separation coefficient of zirconium and hafnium is up to 27.

### Example 2

The organic phase consisted of DIBK by 90% (v/v), Cyanex 921 by 2% (v/v) and sulfonated kerosene (as diluent) by 8% (v/v). Pre-extraction was performed in isometric 3.4 mol/L hydrochloric acid in advance. The aqueous phase consisted of zirconium and hafnium ions at an initial total concentration of 1.5 mol/L, wherein the concentration of hafnium ions was 0.018 mol/L, and the acidity of the aqueous phase was 1.7 mol/L. (NH₄)₂SO₄ was added in an amount of 0.8 mol/L. The phase ratio was kept at 2:1. Single-stage extraction was done at room temperature. The two phases were mixed for 5 min. Raffinate and hafnium-containing loaded organic phase were obtained after phase separating. Ammonium hydroxide was added to the raffinate to precipitate the zirconium, giving zirconium hydroxide precipitate. The loaded organic phase was stripped with 1.0 mol/L potassium carbonate solution. The phase ratio for both washing and stripping was 1:2. The two phases were mixed for 5 min. Hafnium-rich solution containing zirconium was obtained. Ammonium hydroxide was added to precipitate the hafnium, giving hafnium hydroxide precipitate containing zirconium. The other operation steps are same as Example 1.

The extraction rate for hafnium was 58.98%. The extraction rate for zirconium was 11.03%. The separation coefficient of zirconium and hafnium was up to 10.

### Example 3

The organic phase consisted of DIBK by 90% (v/v), Cyanex 923 by 8% (v/v) and isooctane (as diluent) by 2% (v/v). Pre-extraction was performed in isometric 4.0 mol/L hydrochloric acid in advance. The aqueous phase consisted of zirconium and hafnium ions at an initial total concentration of 1.0 mol/L, wherein the concentration of hafnium ions was 0.012 mol/L, and the acidity of the aqueous phase was 2.0 mol/L. (NH₄)₂SO₄ was added in an amount of 0.8 mol/L. The phase ratio was kept at 2:1. Single-stage extraction was done at room temperature. The two phases were mixed for 5 min. Raffinate and hafnium-containing loaded organic phase were obtained after phase separating. Ammonium hydroxide was added to the raffinate to precipitate the zirconium, giving zirconium hydroxide precipitate containing little hafnium. The loaded organic phase was stripped with 1.0 mol/L sodium carbonate solution. The phase ratio for both washing and stripping was 1:2. The two phases were mixed for 5 min. Hafnium-rich solution containing zirconium was obtained. Ammonium hydroxide was added to precipitate the hafnium, giving hafnium hydroxide precipitate containing zirconium. The other operation steps are same as Example 1.

The extraction rate for hafnium was 54.98%. The extraction rate for zirconium was 14.51%. The separation coefficient of zirconium and hafnium was up to 7.

### Example 4

The organic phase consisted of DIBK by 60% (v/v) and Cyanex 925 by 40% (v/v). Pre-extraction was done in 1.0 mol/L hydrochloric acid with an oil/water phase ratio of 1:3 in advance. The aqueous phase consisted of zirconium and hafnium ions at an initial total concentration of 0.5 mol/L, wherein the concentration of hafnium ions was 0.006 mol/L, and the acidity of the aqueous phase was 1.0 mol/L. (NH₄)₂SO₄ was added in an amount of 0.6 mol/L. The phase ratio was kept at 2:1. Single-stage extraction was done at room temperature. The two phases were mixed for 2 min. Raffinate and hafnium-containing loaded organic phase were obtained after phase separating. Sodium hydroxide was added to the raffinate to precipitate zirconium, giving zirconium hydroxide precipitate containing little hafnium. The loaded organic phase was stripped with 3.0 mol/L potassium carbonate solution. The phase ratio for both washing and stripping was 1:2. The two phases were mixed for 5 min. Hafnium-rich solution containing zirconium was obtained, wherein weight ratio (m_{Hf}/m_{(Hf+Zr)}) was 10% in the hafnium-rich solution. Sodium hydroxide was used for precipitation to give hafnium hydroxide precipitate containing zirconium. The other operation steps are same as Example 1.

The extraction rate for hafnium was 64.66%. The extraction rate for zirconium was 14.21%. The separation coefficient of zirconium and hafnium was up to 8.

### Example 5

The organic phase consisted of DIBK by 80% (v/v) and Cyanex 923 by 20% (v/v). Pre-extraction was done in isometric 2.4 mol/L hydrochloric acid in advance. The aqueous phase consisted of zirconium and hafnium ions at an initial total concentration of 1.0 mol/L, wherein the concentration of hafnium ions was 0.012 mol/L. The acidity of the aqueous phase was 1.2 mol/L. (NH₄)₂SO₄ was added in an amount of 1.25 mol/L. The phase ratio was kept at 2:1. Single-stage extraction was done at room temperature. The two phases were mixed for 30 min. Raffinate and hafnium-containing loaded organic phase were obtained after phase separating. Ammonium hydroxide was added to the raffinate to precipitate zirconium, giving zirconium hydroxide precipitate containing little hafnium. The loaded organic phase was stripped with 2.0 mol/L magnesium carbonate solution. The phase ratio for both washing and stripping was 1:2. The two phases were mixed for 5 min. Hafnium-rich solution containing zirconium was obtained, wherein weight ratio (m_{Hf}/m_{(Hf+Zr)}) was 15% in the hafnium-rich solution. Ammonium hydroxide was used for precipitation to give hafnium hydroxide precipitate containing zirconium. The other operation steps are same as Example 1.

The extraction rate for hafnium was 68.22%. The extraction rate for zirconium was 12.25%. The separation coefficient of zirconium and hafnium was up to 12.

### Example 6

The organic phase consisted of DIBK by 70% (v/v) and Cyanex 923 by 30% (v/v). Pre-extraction was done in isometric 4.0 mol/L hydrochloric acid in advance. The aqueous phase consisted of zirconium and hafnium ions at an initial total concentration of 2.0 mol/L. The concentration of hafnium ions was 0.024 mol/L. The acidity of the aqueous phase was 2.0 mol/L. (NH₄)₂SO₄ was added in an amount of 1.0 mol/L. The phase ratio was kept at 2:1. Single-stage extraction was done at room temperature. The two phases were mixed for 25 min. Raffinate and hafnium-containing loaded organic phase were obtained after phase separating. Potassium hydroxide was added to the raffinate to precipitate zirconium, giving zirconium hydroxide precipitate containing little hafnium. The loaded organic phase was stripped with 2.0 mol/L aluminum carbonate solution. The phase ratio for both washing and stripping was 1:2. The two phases were mixed for 25 min. Hafnium-rich solution containing zirconium was obtained, wherein weight ratio (m_{Hf}/m_{(Hf+Zr)}) was 20% in the hafnium-rich solution. Ammonium hydroxide was used for precipitation to give hafnium hydroxide precipitate containing zirconium. The other operation steps are same as Example 1.

The extraction rate for hafnium was 70.78%. The extraction rate for zirconium was 13.64%. The separation coefficient of zirconium and hafnium was up to 15.

### Example 7

The organic phase consisted of DIBK by 85% (v/v) and Cyanex 925 by 15% (v/v). Pre-extraction was done in isometric 4.0 mol/L hydrochloric acid in advance. The aqueous phase consisted of zirconium and hafnium ions at an initial total concentration of 0.5 mol/L, wherein the concentration of hafnium ions was 0.006 mol/L. The acidity of the aqueous phase was 2.0 mol/L. (NH₄)₂SO₄ was added in an amount of 0.8 mol/L. The phase ratio was kept at 2:1. Single-stage extraction was done at room temperature. The two phases were mixed for 10 min. Raffinate and hafnium-containing loaded organic phase were obtained after phase separating. Ammonium hydroxide was added to the raffinate to precipitate zirconium, giving zirconium hydroxide precipitate containing little hafnium. The loaded organic phase was stripped with 3.0 mol/L sodium carbonate solution. The phase ratio for both washing and stripping was 1:2. The two phases were mixed for 10 min. Hafnium-rich solution containing zirconium was obtained, wherein weight ratio (m_{Hf}/m_{(Hf+Zr)}) was 20% in the hafnium-rich solution. Ammonium hydroxide was used for precipitation to give hafnium hydroxide precipitate containing zirconium. The other operation steps are same as Example 1.

The extraction rate for hafnium was 68.42%. The extraction rate for zirconium was 12.68%. The separation coefficient of zirconium and hafnium was up to 16.

### Example 8

The organic phase consisted of DIBK by 65% (v/v) and Cyanex 923 by 35% (v/v). Pre-extraction was done in isometric 3.4 mol/L hydrochloric acid in advance. The aqueous phase consisted of zirconium and hafnium ions at an initial total concentration of 1.2 mol/L, wherein the concentration of hafnium ions was 0.015 mol/L. The acidity of the aqueous phase was 1.7 mol/L. (NH₄)₂SO₄ was added in an amount of 0.8 mol/L. The phase ratio was kept at 2:1. Single-stage extraction was done at room temperature. The two phases were mixed for 15 min. Raffinate and hafnium-containing loaded organic phase were obtained after phase separating. Ammonium hydroxide was added to the raffinate to precipitate zirconium, giving zirconium hydroxide precipitate containing little hafnium. The loaded organic phase was stripped with 1.0 mol/L sodium carbonate solution. The phase ratio for both washing and stripping was 1:2. The two phases were mixed for 15 min. Hafnium-rich solution containing zirconium was obtained, wherein weight ratio (m_{Hf}/m_{(Hf+Zr)}) was 35% in the hafnium-rich solution. Ammonium hydroxide was used for precipitation to give hafnium hydroxide precipitate containing zirconium. The other operation steps are same as Example 1.

The extraction rate for hafnium was 82.50%. The extraction rate for zirconium was 14.50%. The separation coefficient of zirconium and hafnium was up to 28.

### Example 9

The organic phase consisted of DIBK by 90% (v/v), Cyanex 923 by 2% (v/v) and hexane by 8% (v/v). Pre-extraction was performed in isometric 2.0 mol/L hydrochloric acid in advance. The aqueous phase consisted of zirconium and hafnium ions at an initial total concentration of 1.5 mol/L, wherein the concentration of hafnium ions was 0.018 mol/L. The acidity of the aqueous phase was 1.0 mol/L. (NH₄)₂SO₄ was added in an amount of 0.4 mol/L. The phase ratio was kept at 2:1. Single-stage extraction was done at room temperature. The two phases were mixed for 5 min. Raffinate and hafnium-containing loaded organic phase were obtained after phase separating. Ammonium hydroxide was added to the raffinate to precipitate the zirconium, giving zirconium hydroxide precipitate containing little hafnium. The loaded organic phase was stripped with 2.0 mol/L sodium carbonate solution. The phase ratio for both washing and stripping was 1:2. The two phases were mixed for 5 min. Hafnium-rich solution containing zirconium was obtained. Ammonium hydroxide was added to precipitate the hafnium, giving hafnium hydroxide precipitate containing zirconium. The other operation steps are same as Example 1.

The extraction rate for hafnium was 62.55%. The extraction rate for zirconium was 11.84%. The separation coefficient of zirconium and hafnium was up to 8.

### Example 10

The organic phase consisted of DIBK by 90% (v/v), Cyanex923 by 8% (v/v) and 200# solvent by 2% (v/v). Pre-extraction was performed in isometric 4.0 mol/L hydrochloric acid in advance. The aqueous phase consisted of zirconium and hafnium ions at an initial total concentration of 2.0 mol/L, wherein the concentration of hafnium ions was 0.024 mol/L. The acidity of the aqueous phase was 1.9 mol/L. (NH₄)₂SO₄ was added in an amount of 0.8 mol/L. The phase ratio was kept at 2:1. Single-stage extraction was done at room temperature. The two phases were mixed for 10 min. Raffinate and hafnium-containing loaded organic phase were obtained after phase separating. Ammonium hydroxide was added to the raffinate to precipitate the zirconium, giving zirconium hydroxide precipitate containing little hafnium. The loaded organic phase was stripped with 1.5 mol/L sodium carbonate solution. The phase ratio for both washing and stripping was 1:2. The two phases were mixed for 10 min. Hafnium-rich solution containing zirconium was obtained. Ammonium hydroxide was added to precipitate the hafnium, giving hafnium hydroxide precipitate containing zirconium. The other operation steps are same as Example 1.

The extraction rate for hafnium was 68.44%. The extraction rate for zirconium was 12.62%. The separation coefficient of zirconium and hafnium was up to 9.

### Example 11

The organic phase consisted of DIBK by 90% (v/v) and Cyanex 925 by 10% (v/v). Pre-extraction was performed in isometric 3.0 mol/L hydrochloric acid in advance. The aqueous phase consisted of zirconium and hafnium ions at an initial total concentration of 1.5 mol/L, wherein the concentration of hafnium ions was 0.018 mol/L. The acidity of the aqueous phase was 1.5 mol/L. (NH₄)₂SO₄ was added in an amount of 0.4 mol/L. The phase ratio was kept at 2:1. Single-stage extraction was done at room temperature. The two phases were mixed for 10 min. Raffinate and hafnium-containing loaded organic phase were obtained after phase separating. Ammonium hydroxide was added to the raffinate to precipitate the zirconium, giving zirconium hydroxide precipitate. The loaded organic phase was stripped with 1.0 mol/L potassium carbonate solution. The phase ratio for both washing and stripping was 1:2. The two phases were mixed for 10 min. Hafnium-rich solution containing zirconium was obtained. Ammonium hydroxide was added to precipitate the hafnium, giving hafnium hydroxide precipitate containing zirconium. The other operation steps are same as Example 1.

The extraction rate for hafnium was 58.98%. The extraction rate for zirconium was 11.03%. The separation coefficient of zirconium and hafnium was up to 10.

### Example 12

The organic phase consisted of DIBK by 90% (v/v), Cyanex 572 by 2% (v/v) and sulfonated kerosene (as diluent) by 8% (v/v). Pre-extraction was performed in isometric 2.8 mol/L hydrochloric acid in advance. The aqueous phase consisted of zirconium and hafnium ions at an initial total concentration of 1.5 mol/L, wherein the concentration of hafnium ions was 0.018 mol/L. The acidity of the aqueous phase was 1.4 mol/L. (NH₄)₂SO₄ was added in an amount of 0.6 mol/L. The phase ratio was kept at 2:1. Single-stage extraction was done at room temperature. The two phases were mixed for 5 min. Raffinate and hafnium-containing loaded organic phase were obtained after phase separating. Ammonium hydroxide was added to the raffinate to precipitate the zirconium, giving zirconium hydroxide precipitate. The loaded organic phase was stripped with 1.0 mol/L potassium carbonate solution. The phase ratio for both washing and stripping was 1:2. The two phases were mixed for 5 min. Hafnium-rich solution containing zirconium was obtained. Ammonium hydroxide was added to precipitate the hafnium, giving hafnium hydroxide precipitate containing zirconium. The other operation steps are same as Example 1.

The extraction rate for hafnium was 44.81%. The extraction rate for zirconium was 11.22%. The separation coefficient of zirconium and hafnium was up to 7.

### Example 13

The organic phase consisted of DIBK by 90% (v/v), Cyanex 572 by 8% (v/v) and sulfonated kerosene (as diluent) by 2% (v/v). Pre-extraction was performed in isometric 2.8 mol/L hydrochloric acid in advance. The aqueous phase consisted of zirconium and hafnium ions at an initial total concentration of 1.5 mol/L, wherein the concentration of hafnium ions was 0.018 mol/L. The acidity of the aqueous phase was 1.4 mol/L. (NH₄)₂SO₄ was added in an amount of 0.6 mol/L. The phase ratio was kept at 2:1. Single-stage extraction was done at room temperature. The two phases were mixed for 5 min. Raffinate and hafnium-containing loaded organic phase were obtained after phase separating. Ammonium hydroxide was added to the raffinate to precipitate the zirconium, giving zirconium hydroxide precipitate containing little hafnium. The loaded organic phase was stripped with 1.0 mol/L sodium carbonate solution. The phase ratio for both washing and stripping was 1:2. The two phases were mixed for 5 min. Hafnium-rich solution containing zirconium was obtained. Ammonium hydroxide was added to precipitate the hafnium, giving hafnium hydroxide precipitate containing zirconium. The other operation steps are same as Example 1.

The extraction rate for hafnium was 50.28%. The extraction rate for zirconium was 12.64%. The separation coefficient of zirconium and hafnium was up to 10.

### Example 14

The organic phase consisted of DIBK by 60% (v/v) and Cyanex 572 by 40% (v/v). Pre-extraction was done in isometric 3.0 mol/L hydrochloric acid in advance. The aqueous phase consisted of zirconium and hafnium ions at an initial total concentration of 0.5 mol/L, wherein the concentration of hafnium ions was 0.006 mol/L. The acidity of the aqueous phase was 1.5 mol/L. NH₄Cl was added in an amount of 0.6 mol/L. The phase ratio was kept at 2:1. Single-stage extraction was done at room temperature. The two phases were mixed for 2 min. Raffinate and hafnium-containing loaded organic phase were obtained after phase separating. Sodium hydroxide was added to the raffinate to precipitate zirconium, giving zirconium hydroxide precipitate containing little hafnium. The loaded organic phase was stripped with 3.0 mol/L potassium carbonate solution. The phase ratio for both washing and stripping was 1:2. The two phases were mixed for 5 min. Hafnium-rich solution containing zirconium was obtained, wherein weight ratio (m_{Hf}/m_{(Hf+Zr)}) was 13% in the hafnium-rich solution. Sodium hydroxide was used for precipitation to give hafnium hydroxide precipitate containing zirconium. The other operation steps are same as Example 1.

The extraction rate for hafnium was 52.42%. The extraction rate for zirconium was 13.22%. The separation coefficient of zirconium and hafnium was up to 8.

### Example 15

The organic phase consisted of DIBK by 80% (v/v) and Cyanex 923 by 20% (v/v). Pre-extraction was done in isometric 3.2 mol/L hydrochloric acid in advance. The aqueous phase consisted of zirconium and hafnium ions at an initial total concentration of 1.0 mol/L, wherein the concentration of hafnium ions was 0.012 mol/L. The acidity of the aqueous phase was 1.6 mol/L. (NH₄)₂SO₄ was added in an amount of 1.25 mol/L. The phase ratio was kept at 2:1. Single-stage extraction was done at room temperature. The two phases were mixed for 30 min. Raffinate and hafnium-containing loaded organic phase were obtained after phase separating. Ammonium hydroxide was added to the raffinate to precipitate zirconium, giving zirconium hydroxide precipitate containing little hafnium. The loaded organic phase was stripped with 2.0 mol/L magnesium carbonate solution. The phase ratio for both washing and stripping was 1:2. The two phases were mixed for 5 min. Hafnium-rich solution containing zirconium was obtained, wherein weight ratio (m_{Hf}/m_{(Hf+Zr)}) was 30% in the hafnium-rich solution. Ammonium hydroxide was used for precipitation to give hafnium hydroxide precipitate containing zirconium. The other operation steps are same as Example 1.

The extraction rate for hafnium was 70.58%. The extraction rate for zirconium was 11.53%. The separation coefficient of zirconium and hafnium was up to 18.

### Example 16

The organic phase consisted of DIBK by 70% (v/v) and Cyanex 921 by 30% (v/v). Pre-extraction was done in isometric 4.0 mol/L hydrochloric acid in advance. The aqueous phase consisted of zirconium and hafnium ions at an initial total concentration of 2.0 mol/L, wherein the concentration of hafnium ions was 0.024 mol/L. The acidity of the aqueous phase was 2.0 mol/L. (NH₄)₂SO₄ was added in an amount of 0.8 mol/L. The phase ratio was kept at 2:1. Single-stage extraction was done at room temperature. The two phases were mixed for 25 min. Raffinate and hafnium-containing loaded organic phase were obtained after phase separating. Potassium hydroxide was added to the raffinate to precipitate zirconium, giving zirconium hydroxide precipitate containing little hafnium. The loaded organic phase was stripped with 2.0 mol/L aluminum carbonate solution. The phase ratio for both washing and stripping was 1:2. The two phases were mixed for 25 min. Hafnium-rich solution containing zirconium was obtained, wherein weight ratio (m_{Hf}/m_{(Hf+Zr)}) was 30% in the hafnium-rich solution. Ammonium hydroxide was used for precipitation to give hafnium hydroxide precipitate containing zirconium. The other operation steps are same as Example 1.

The extraction rate for hafnium was 73.06%. The extraction rate for zirconium was 11.66%. The separation coefficient of zirconium and hafnium was up to 18.

### Example 17

The organic phase consisted of DIBK by 85% (v/v) and Cyanex 572 by 15% (v/v). Pre-extraction was done in isometric 2.8 mol/L hydrochloric acid in advance. The aqueous phase consisted of zirconium and hafnium ions at an initial total concentration of 0.05 mol/L, wherein the concentration of hafnium ions was 0.0006 mol/L. The acidity of the aqueous phase was 1.4 mol/L. (NH₄)₂SO₄ was added in an amount of 0.8 mol/L. The phase ratio was kept at 2:1. Single-stage extraction was done at room temperature. The two phases were mixed for 10 min. Raffinate and hafnium-containing loaded organic phase were obtained after phase separating. Ammonium hydroxide was added to the raffinate to precipitate zirconium, giving zirconium hydroxide precipitate containing little hafnium. The loaded organic phase was stripped with 3.0 mol/L sodium carbonate solution. The phase ratio for both washing and stripping was 1:2. The two phases were mixed for 10 min. Hafnium-rich solution containing zirconium was obtained, wherein weight ratio (m_{Hf}/m_{(Hf+Zr)}) was 15% in the hafnium-rich solution. Ammonium hydroxide was used for precipitation to give hafnium hydroxide precipitate containing zirconium. The other operation steps are same as Example 1.

The extraction rate for hafnium was 48.32%. The extraction rate for zirconium was 11.68%. The separation coefficient of zirconium and hafnium was up to 10.

### Example 18

The organic phase consisted of DIBK by 65% (v/v) and Cyanex 572 by 35% (v/v). Pre-extraction was done in isometric 3.0 mol/L hydrochloric acid in advance. The aqueous phase consisted of zirconium and hafnium ions at an initial total concentration of 1.0 mol/L, wherein the concentration of hafnium ions was 0.012 mol/L. The acidity of the aqueous phase was 1.5 mol/L. MgCl₂ was added in an amount of 0.4 mol/L. The phase ratio was kept at 2:1. Single-stage extraction was done at room temperature. The two phases were mixed for 15 min. Raffinate and hafnium-containing loaded organic phase were obtained after phase separating. Ammonium hydroxide was added to the raffinate to precipitate zirconium, giving zirconium hydroxide precipitate containing little hafnium. The loaded organic phase was stripped with 1.5 mol/L sodium carbonate. The phase ratio for both washing and stripping was 1:2. The two phases were mixed for 15 min. Hafnium-rich solution containing zirconium was obtained, wherein weight ratio (m_{Hf}/m_{(Hf+Zr)}) was 13% in the hafnium-rich solution. Ammonium hydroxide was used for precipitation to give hafnium hydroxide precipitate containing zirconium. The other operation steps are same as Example 1.

The extraction rate for hafnium was 48.48%. The extraction rate for zirconium was 12.24%. The separation coefficient of zirconium and hafnium was up to 8.

### Example 19

The organic phase consisted of DIBK by 90% (v/v), Cyanex 923 by 8% (v/v) and Cyanex 923 by 2% (v/v). Pre-extraction was performed in isometric 3.6 mol/L hydrochloric acid in advance. The aqueous phase consisted of zirconium and hafnium ions at an initial total concentration of 1.5 mol/L, wherein the concentration of hafnium ions was 0.018 mol/L. The acidity of the aqueous phase was 1.8 mol/L. (NH₄)₂SO₄ was added in an amount of 0.8 mol/L. The phase ratio was kept at 2:1. Single-stage extraction was done at room temperature. The two phases were mixed for 5 min. Raffinate and hafnium-containing loaded organic phase were obtained after phase separating. Ammonium hydroxide was added to the raffinate to precipitate the zirconium, giving zirconium hydroxide precipitate containing little hafnium. The loaded organic phase was stripped with 2.5 mol/L sodium carbonate solution. The phase ratio for both washing and stripping was 1:2. The two phases were mixed for 5 min. Hafnium-rich solution containing zirconium was obtained. Ammonium hydroxide was added to precipitate the hafnium, giving hafnium hydroxide precipitate containing zirconium. The other operation steps are same as Example 1.

The extraction rate for hafnium was 82.48%. The extraction rate for zirconium was 10.20%. The separation coefficient of zirconium and hafnium was up to 36.

### Example 20

The organic phase consisted of DIBK by 90% (v/v), Cyanex 572 by 8% (v/v) and isooctane by 2% (v/v). Pre-extraction was performed in isometric 2.8 mol/L hydrochloric acid in advance. The aqueous phase consisted of zirconium and hafnium ions at an initial total concentration of 2.0 mol/L, wherein the concentration of hafnium ions was 0.024 mol/L. The acidity of the aqueous phase was 1.4 mol/L. NaCl was added in an amount of 0.8 mol/L. The phase ratio was kept at 2:1. Single-stage extraction was done at room temperature. The two phases were mixed for 10 min. Raffinate and hafnium-containing loaded organic phase were obtained after phase separating. Ammonium hydroxide was added to the raffinate to precipitate the zirconium, giving zirconium hydroxide precipitate containing little hafnium. The loaded organic phase was stripped with 1.5 mol/L sodium carbonate solution. The phase ratio for both washing and stripping was 1:2. The two phases were mixed for 10 min. Hafnium-rich solution containing zirconium was obtained. Ammonium hydroxide was added to precipitate the hafnium, giving hafnium hydroxide precipitate containing zirconium. The other operation steps are same as Example 1.

The extraction rate for hafnium was 45.22%. The extraction rate for zirconium was 10.48%. The separation coefficient of zirconium and hafnium was up to 9.

### Example 21

The present example differs from Example 1 in that the synergistic extraction system used is different. In the present example, the used synergistic extraction system consisted of DIBK by 90% (v/v), Cyanex 923 by 5% (v/v) and Cyanex 572 by 5% (v/v). The ratio of other raw materials and the preparation method are all the same.

The examples described above are only some but not all of the examples of the present disclosure. Hence, the detailed description of the examples of the present disclosure is not intended to limit the scope of the disclosure as claimed, but merely shows the selected examples of the present disclosure. All the other embodiments obtained by those ordinarily skilled in the art based on the embodiments provided in the present disclosure without paying creative efforts shall fall within the scope of protection of the present disclosure.

1. A method of extracting and separating zirconium and hafnium from hydrochloric acid medium, comprising following steps:
mixing an extraction agent with acidic raw liquid for extraction, with the acidic raw liquid formed by mixing a zirconium-containing chemical and hydrochloric acid; mixing obtained raffinate from phase separation of the extraction with a base solution to give zirconium hydroxide precipitate; stripping hafnium-containing loaded organic phase with a carbonate solution; mixing stripping liquid with a base solution to give hafnium hydroxide precipitate, and roasting the zirconium hydroxide precipitate and the hafnium hydroxide precipitate, wherein the extraction agent comprises mixture consisted of diisobutyl ketone (DIBK) and phosphonic acids extraction agent.

2. The method of extracting and separating zirconium and hafnium from hydrochloric acid medium according to claim 1, wherein free acid is present in the acidic raw liquid at a total acidity of 0.5˜4.0 mol/L; and/or
zirconium ions and hafnium ions are present in the acidic raw liquid at a total concentration of 0.05˜2.0 mol/L.

3. The method of extracting and separating zirconium and hafnium from hydrochloric acid medium according to claim 2, wherein chlorine ions are present in the acidic raw liquid at a concentration of 0.5˜5.0 mol/L; and/or
sulfate ions are present at a concentration of 0˜1.25 mol/L.

4. The method of extracting and separating zirconium and hafnium from hydrochloric acid medium according to claim 1, wherein the inorganic salt is at least one selected from the group consisting of ammonium chloride, sodium chloride, magnesium chloride, ammonium sulfate and sodium sulfate.

5. The method of extracting and separating zirconium and hafnium from hydrochloric acid medium according to claim 1, wherein the phosphonic acids extraction agent has a volume percentage of 2˜40% (v/v), in the extraction agent; and/or
weight ratio, which is m_{Hf}/m_{(Hf+Zr)}, is 10˜40% in the stripping liquid.

6. The method of extracting and separating zirconium and hafnium from hydrochloric acid medium according to claim 5, wherein the extraction agent is mixed with a diluent before extraction.

7. The method of extracting and separating zirconium and hafnium from hydrochloric acid medium according to claim 1, wherein the extraction is performed in a single-stage or multi-stage co-current flow and/or counter flow manner.

8. The method of extracting and separating zirconium and hafnium from hydrochloric acid medium according to claim 1, wherein the carbonate is at least one selected from the group consisting of sodium carbonate, sodium bicarbonate, potassium carbonate, potassium bicarbonate, ammonium carbonate, magnesium carbonate and aluminum carbonate.

9. The method of extracting and separating zirconium and hafnium from hydrochloric acid medium according to claim 1, wherein the roasting is performed at 600˜2300° C., and/or the zirconium hydroxide precipitate and the hafnium hydroxide precipitate are washed before roasting.

10. A method of extracting and separating zirconium and hafnium from hydrochloric acid medium, comprising mixing a zirconium-containing chemical and hydrochloric acid to form acidic raw liquid,
performing extraction to the acidic raw liquid using an extraction agent to give raffinate and hafnium-containing loaded organic phase after phase separation of the extraction, mixing the raffinate with a base solution to give zirconium hydroxide precipitate, stripping the hafnium-containing loaded organic phase with carbonate solution, mixing stripping liquid with a base solution to give hafnium hydroxide precipitate, and roasting the zirconium hydroxide precipitate and the hafnium hydroxide precipitate, wherein the extraction agent comprises mixture consisted of DIBK and phosphonic acids extraction agent.

11. The method of extracting and separating zirconium and hafnium from hydrochloric acid medium according to claim 1, wherein the phosphonic acids extraction agent is at least one selected from the group consisting of Cyanex 921, Cyanex 923, Cyanex 925 and Cyanex 572.

12. The method of extracting and separating zirconium and hafnium from hydrochloric acid medium according to claim 1, wherein the hydrochloric acid is pre-extracted with the extraction agent before extraction.

13. The method of extracting and separating zirconium and hafnium from hydrochloric acid medium according to claim 1, wherein the hydrochloric acid has a concentration of 1.0˜4.0 mol/L in pre-extraction, and/or the extraction agent is isometric with the hydrochloric acid in pre-extraction.

14. The method of extracting and separating zirconium and hafnium from hydrochloric acid medium according to claim 1, wherein the acidic raw liquid further comprises inorganic salt.

15. The method of extracting and separating zirconium and hafnium from hydrochloric acid medium according to claim 2, wherein the free acid is present in the acidic raw liquid at a total acidity of 1.0˜2.5 mol/L.

16. The method of extracting and separating zirconium and hafnium from hydrochloric acid medium according to claim 2, wherein zirconium ions and hafnium ions are present in the acidic raw liquid at a total concentration of 0.5˜1.5 mol/L.

17. The method of extracting and separating zirconium and hafnium from hydrochloric acid medium according to claim 3, wherein chlorine ions are present in the acidic raw liquid at a concentration of 2.0˜4.0 mol/L.

18. The method of extracting and separating zirconium and hafnium from hydrochloric acid medium according to claim 6, wherein the diluent is at least one selected from the group consisting of sulfonated kerosene, hexane, isooctane and 200# solvent oil.

19. The method of extracting and separating zirconium and hafnium from hydrochloric acid medium according to claim 7, wherein two phases are mixed for 2˜30 min.

20. The method of extracting and separating zirconium and hafnium from hydrochloric acid medium according to claim 7, wherein an intra-tank temperature within an extraction tank is 0˜40° C. during extraction.
